(19) United States
(12) Patent Application Publication
(10) Pub. No.: US 2020/0215866 A1
(43) Pub. Date: Jul. 9, 2020

(54) MULTI-LIFTING-TANDEMS SUSPENSION

(71) Applicant: LIFTMASTER LTD., Woodbridge (CA)

(72) Inventors: On HOTER ISHAY, Woodbridge (CA); Mark ALDROVANDI, Woodbridge (CA)

(21) Appl. No.: 16/242,727

(22) Filed: Jan. 8, 2019

(51) Int. Cl. B60G 17/0165; B60G 7/00

(52) U.S. Cl. CPC B60G 17/0165; B60K 17/10; B60G 7/001

(57) ABSTRACT

A vehicle with a chassis supported by a multiple-lifting-tandems suspension of four, six, eight, ten or twelves lifting tandem pairs, where each lifting tandem pair comprises a front wheel and a rear wheel rotatably mounted to a rocker arm whereas both wheels may or may not be steerable; a link arm having a proximal end rotatably mounted to the chassis and a distal end rotatably mounted to a central portion of the rocker arm; an actuator having a proximal end rotatably mounted to the chassis a distance from the proximal end of the link arm and a distal end rotatably mounted to a central portion of the rocker arm or to a distal end of the link arm, the actuator extending to move the rocker arm to an extended position and retracting to move the rocker arm to a retracted position; and drive means engaging each front wheel and each rear wheel.

### TECHNICAL FIELD

The invention relates to a lifting suspension system for an off-road automotive wheeled vehicle chassis based on pairs of lifting tandem wheels, where each pair can be actively and independently raised or lowered with dedicated subsystems for maintaining wheel contact over rough terrain, while modulating heave, roll and pitch motions of the chassis.

### BACKGROUND OF THE ART

The mobility of any wheeled-vehicle depends on the traction of the vehicle's wheels over the travelled surface and the vehicle's ground pressure. Ground pressure is the ratio between the overall weight of the vehicle and the contact surface area of the wheels on the ground surface. For example, in off road applications, the tire inflation pressure is often reduced in order to increase the tire's contact surface area and improve compliance of the flexible tire with uneven ground surfaces.

Well recognised design solutions for improved traction and ground surface area are increasing the number of the wheels, using belt tracks and/or increasing the travel of suspension systems. The vehicle's suspension system performs the role of maintaining contact between the vehicle's wheels and the ground. The torsional rigidity of the vehicle chassis dictates that it is the wheels that move vertically supported by the suspension. However, driving over the uneven surface of regular off-road terrain, in many cases not all the vehicle's wheels are in constant or efficient contact with the ground surface. Limited slip differential is a feature also used to direct engine power to the wheels that are in ground contact to somewhat ameliorate the problem of one or more spinning wheels that are not in contact with the ground.

Improvements to these conventional solutions to off road traction issues are desirable.

Features that distinguish the present invention from the background art will be apparent from review of the disclosure, drawings and description of the invention presented below.

### DISCLOSURE OF THE INVENTION

An embodiment of the invention provides a vehicle with a chassis supported by a multi-lifting-tandems suspension of four or more lifting tandem pairs, where each lifting tandem pair comprises a front wheel and a rear wheel rotatably mounted to a rocker arm; a link arm having a proximal end rotatably mounted to the chassis and a distal end rotatably mounted to a central portion of the rocker arm between the pair of tandem wheels—whether at the center of the rocker arm, or off-center; an actuator having a proximal end rotatably mounted to the chassis a distance from the proximal end of the link arm and a distal end of the link arm rotatably mounted to a central portion of the rocker arm or to a distal end of the link arm, the actuator extending to move the rocker arm to an extended position and retracting to move the rocker arm to a retracted position; and drive means engaging each front wheel and each rear wheel of each of the four lifting tandem pairs. The wheels of the two front lifting tandem pairs can be steerable using a vehicle steering system.

The term “lifting tandem pair”, refers to two wheels with parallel rotating axles, mounted one behind the other on a common rocker arm for support. Each lifting tandem pair—whether the wheels are steerable or not—is able to oscillate about the central axis of the rocker arm.

The central axis of the rocker arm is located between the axles of the two wheels—whether in the exact middle between the two axles of the wheels or off-centre, and is parallel to the axles of the two wheels. The example described and illustrated herein is based on four lifting tandem pairs, mounted at the four corners of the vehicle chassis. The supporting suspension system allows each lifting tandem pair individually significant vertical motion—without jeopardizing the oscillation capability of the rocker arm around its own central axle. Preferably the four wheels of the two front lifting tandem pairs are steerable. All eight wheels (four rocker arms, each with two wheels) of the multi-lifting-tandems suspension, can maintain full contact with the ground surface, even over extremely rough terrain or transverse slopes—to the limit of the vertical displacement of each individual lifting tandem pair.

### DESCRIPTION OF THE DRAWINGS

In order that the invention may be readily understood, one embodiment of the invention is illustrated by way of example in the accompanying drawings.

FIG. 1 is a schematic side view of a vehicle chassis with two lifting tandem pairs of wheels on each side of the vehicle (hence the label “Multi-Lifting-Tandems”) joined with a rocker arm, each rocker arm being joined to the chassis with a link arm and actuated directly and independently by a hydraulic cylinder to the extended position to engage the uneven ground surface.

FIG. 2 is a schematic side view of the multi-lifting-tandems suspension with hydraulic cylinders in an extended position, the chevron shaped rocker arm and lozenge shaped link arm being in dashed outline to better show the sprocket and chain drive system.

FIG. 3 is a schematic side view of the multi-lifting-tandems suspension with hydraulic cylinders in a retracted position.

FIG. 4 is a schematic side view of the vehicle ascending or descending an incline with the one lifting tandem pair extended and the other lifting tandem pair retracted to level the chassis.

FIG. 5 is a schematic side view of the vehicle traversing relatively level ground with both lifting tandem pairs retracted.

FIG. 6 is a section view along line A-A of FIG. 5, showing the left lifting tandem pair and the right lifting tandem pair retracted over level ground.

FIG. 7 is a section view showing the left lifting tandem pair extended and the right lifting tandem pair retracted over an inclined ground surface.

FIG. 8 is a section view showing both lifting tandem pairs extended to traverse over large protruding obstacles on the ground surface, or for fording a water obstacle.

FIG. 9 is a section view showing the left lifting tandem pair retracted and the right lifting tandem pair extended over an inclined ground surface opposite to FIG. 7.

FIG. 10 is a schematic side view of an alternative vehicle chassis, similar to FIG. 1 with two lifting tandem pairs of wheels on each side of the vehicle actuated directly and independently by a hydraulic cylinder extending from the central portion of the chassis but having two drive axes at opposite ends of the chassis.

Further details of the invention and its advantages will be apparent from the detailed description included below.

### DETAILED DESCRIPTION OF PREFERRED EMBODIMENTS

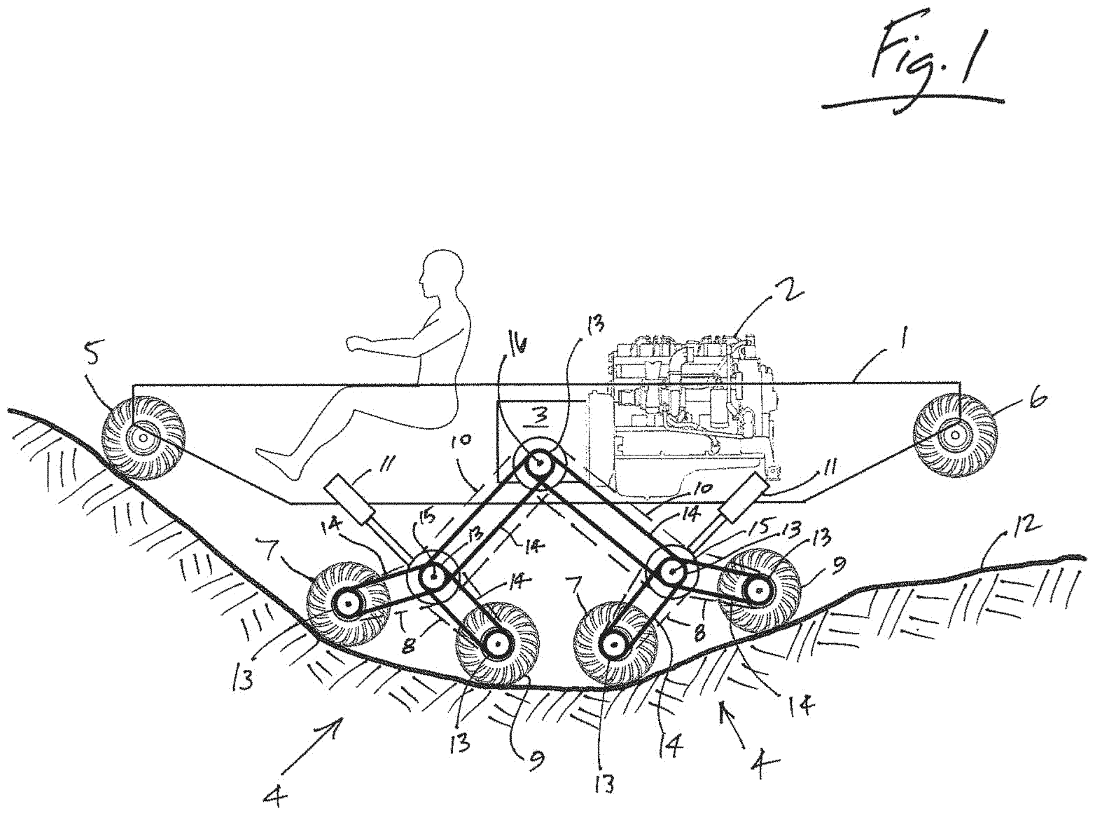

FIG. 1 shows a vehicle chassis 1 with an engine 2 and transmission 3 disposed in a central portion of the chassis 1. The multi-lifting-tandems suspension can include any pair number of lifting tandem pairs 4, but in the example illustrated and described herein, there are four lifting tandem pairs 4, two on each side of the chassis 1.

In the example shown, the chassis 1 includes an optional pair of auxiliary approach idler wheels 5 rotatably mounted to a forward edge of the chassis 1 and an optional pair of auxiliary departure idler wheels 6 rotatably mounted to a rearward edge. The auxiliary idler wheels 5, 6 are not power driven but are rotatably mounted to freely rotate when a steep ground surface or other obstacle is engaged during approach or departure. The auxiliary idler wheels also serve as replacement spare wheels for use if some of the tires of the primary drive wheels are punctured or otherwise damaged.

The drive force of the engine 2 is transmitted to the drive wheels of each lifting tandem pair 4 via a chain or belt drive system. Each lifting tandem pair 4 comprising a front wheel 7 rotatably mounted to a front portion of a rocker arm 8 and a rear wheel 9 rotatably mounted to a rear portion of the rocker arm 8. If electric—or hydraulic—power is used, a hub of each wheel 7, 9 could be driven by an independently controlled electric—or hydraulic—motor.

A link arm 10 has a proximal end rotatably mounted to the chassis 1 and engages the transmission 3. A distal end of the link arm 10 is rotatably mounted to a central portion of the rocker arm 8—off-center towards the rear of the rocker arm, for facilitating climbing of the front wheel of the lifting tandem pair.

An actuator 11 can be a hydraulic cylinder, a pneumatic cylinder, or an electrically powered linear actuator depending on the selected power source. That actuator can incorporate a cushioning device, enabling smooth ride in high speeds. The actuator 11 has a proximal end rotatably mounted to the chassis 1 a distance from the proximal end of the link arm which is also rotatably mounted to the chassis 1. A distal end of the actuator 11 is rotatably mounted to a central portion of the rocker arm 8 or to a distal end of the link arm. Therefore, with the actuator 11 and link arms 10 rotatably connecting the chassis 1 and rocker arms 8, a movable linkage system is provided to significantly raise and lower each side of the chassis relative to the ground surface 12. The actuators 11 can be independently extended and retracted as shown in FIGS. 4-9 to adapt to varying terrain. The actuators 11 extend to move the rocker arms 8 to an extended position and retract to move the rocker arms 8 to a retracted position. If required, additional linking arms between the actuators 11 and the rocker arms 8 allows positioning the hydraulic cylinder of the actuator in various positions relative to the chassis. Control of the actuators 11 can be manual or can be automated with various sensors, accelerometers and electronics.

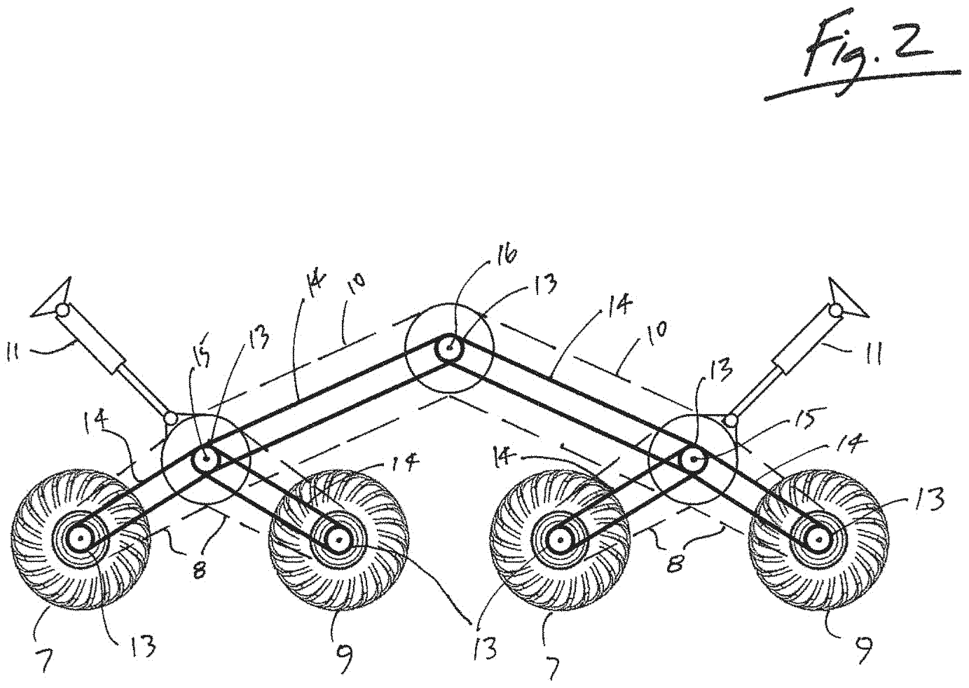

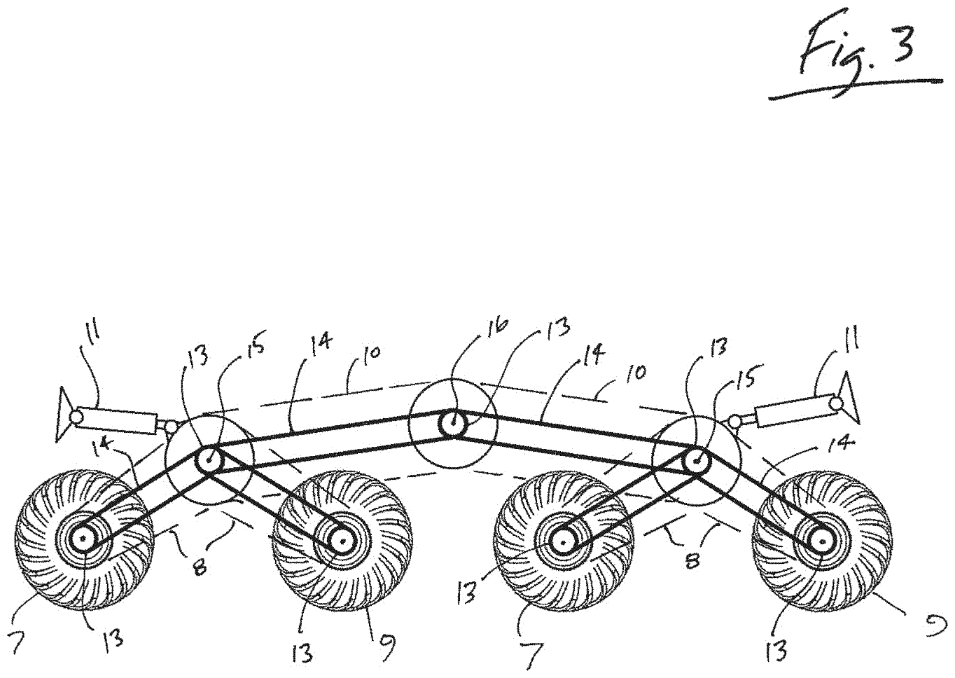

FIG. 2 shows a schematic side view of the multi-lifting-tandems suspension with actuators 11 as hydraulic cylinders in an extended position. FIG. 3 shows the actuators 11 in a retracted position and the lifting tandem suspension linkage retracts the wheels 7, 9 toward the chassis 1 as a result. The chevron shaped rocker arms 8 and lozenge shaped link arms 10 are shown as hollow box members of welded plates of metal in dashed outline to better show an internal sprocket and chain drive system. The details of the rotatable connection between the rocker arms 8, link arms 10 and the actuators 11 are not shown for clarity and such mechanical configurations are well within the common general knowledge of those skilled in mechanics. It is sufficient to note that in this specific embodiment the centers of the linkage connections and centers of the sprockets 13 are coaxial.

As shown in FIG. 1, the drive means can include an engine 2 and transmission 3 that engages each front wheel 7 and each rear wheel 9 via a series of sprockets 13 and chain belts 14. As best seen in FIGS. 2 and 3, the sprockets 13 and chain belts 14 are housed within the interior of the hollow plate metal box shapes of the rocker arms 8 and link arms 10. The actuators 11 have their ends pivotally connected to the chassis 1 and either the rocker arm 8 or the link arm 10 near the rotatable joint between the rocker arm 9 and the link arm 10. The shape and the structure of the rocker arms 8 and the form of the link arm 10 is derived by the positions of the wheels 7 and 9 relative to the chassis 1 and the type of drive used in this embodiment.

As seen in FIGS. 2 and 3, each front wheel 7 and each rear wheel 9 has a hub driven by a sprocket 13 and a belt chain 14. The rocker arm 8 is free to rotate about the central axis 15 and adapts to varying ground surfaces 12. The drive system could also include pulleys instead of sprockets 13. The belt chain 14 could be replaced with a toothed belt drive or V-belt drive. The sprockets 13 within the link arms 10 are connected to the engine 2 and transmission 3 with a sprocket 13 that rotates about the drive axis 16.

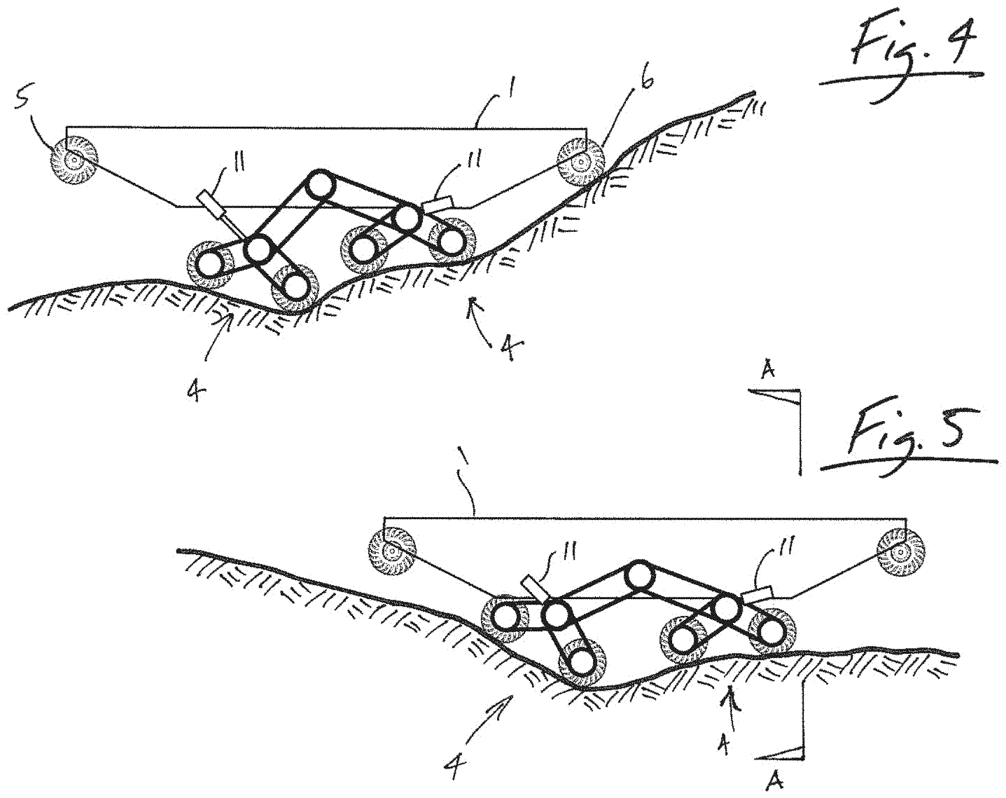

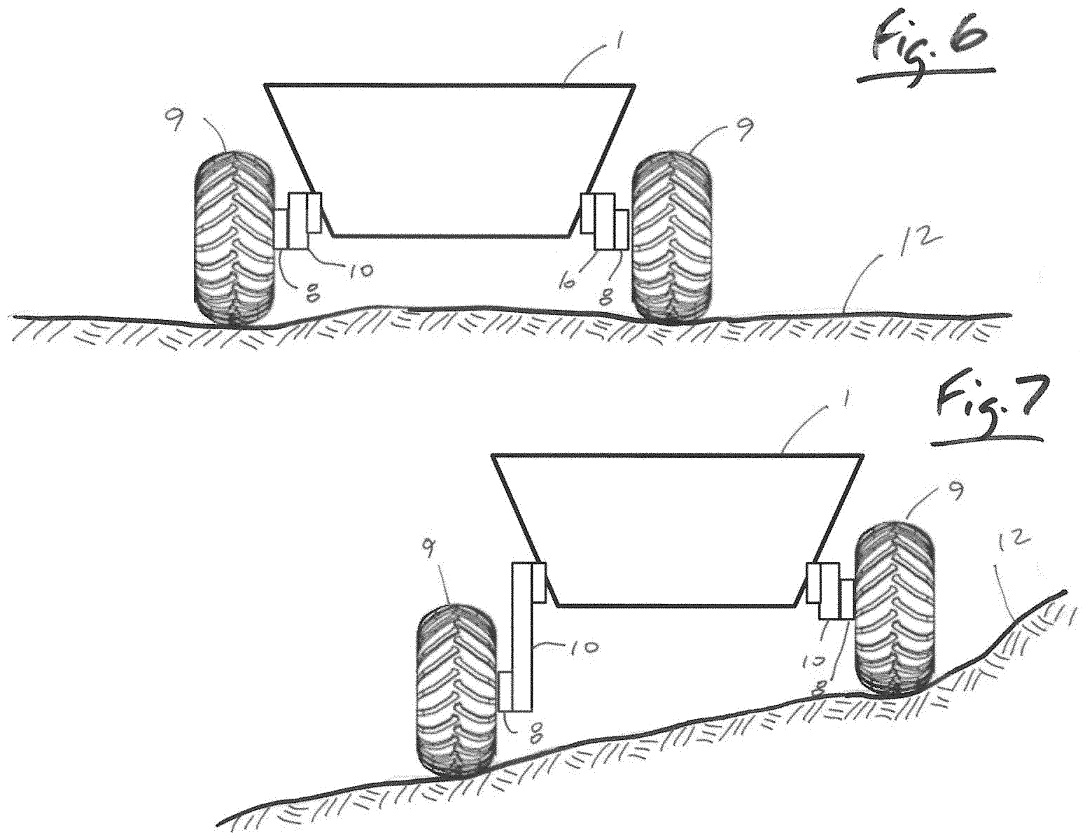

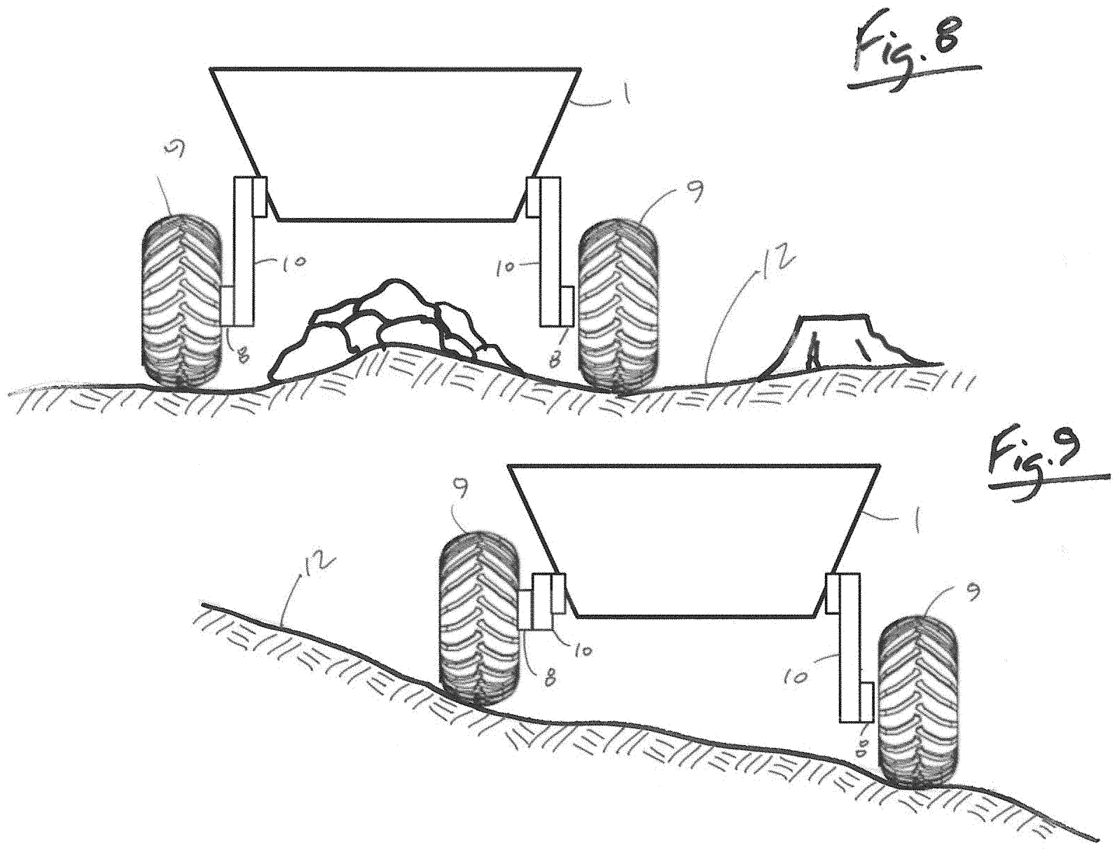

FIGS. 1 and 8 show the actuators 11 in an extended position. FIGS. 5 and 6 show the actuators 11 in a retracted position. FIGS. 4, 7 and 9 show some actuators 11 extended and others retracted to accommodate varying ground surface topographies.

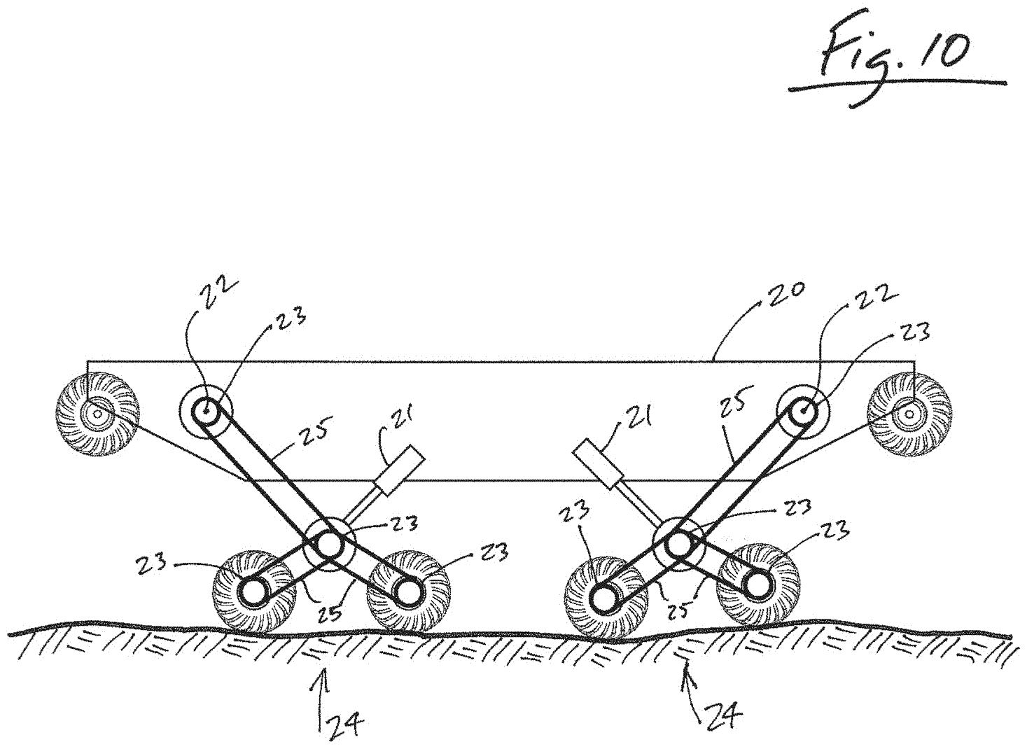

The above description relates to a specific preferred embodiment as presently contemplated by the inventors. In this specific embodiment the multi-lifting-tandems system is configured with the following design parameters: The drive train is configurated with the engine at the center of the vehicle, with one single differential providing equal torque to the two sides of the vehicle (left and right). The power is provided to the wheels through tensioned driving belts. The lifting mechanism is based on four individual hydraulic pistons, each of them independently actuating directly the relevant lifting tandem pair. FIG. 10 shows a side view of an alternative vehicle chassis 20 with two lifting tandem pairs 24 of wheels. The tandem pairs 24 are lifted and lowered directly and independently by an actuator 21 (ex: hydraulic cylinder) extending from the central portion of the chassis 20. At opposite ends of the chassis 20 are two drive axes 22 and sprockets 23 driven by an engine and transmission (not shown) located within the chassis 20. In a like manner described above, the sprockets 23 and chain belts 25 transmit power to each wheel of each tandem pair 24. The proximal ends of the link arms are rotatably mounted to opposite ends of the chassis 20 and the proximal ends of the actuators 21 are rotatably mounted to a central portion of the chassis 20.

It will be understood that the invention in its broad aspect includes mechanical and functional equivalents of the elements described herein.

We claim:

1. A multiple-lifting-tandems suspension for a chassis, comprising a plurality of lifting tandem pairs, each lifting tandem pair comprising a front wheel rotatably mounted to a front portion of a rocker arm and a rear wheel rotatably mounted to a rear portion of the rocker arm, whereas both wheels may or may not be steerable;
a link arm having a proximal end rotatably mounted to the chassis and a distal end rotatably mounted to a central portion of the rocker arm—whether at the center of the rocker arm or off-center;
an actuator having a proximal end rotatably mounted to the chassis a distance from the proximal end of the link arm and a distal end rotatably mounted to a central portion of the rocker arm or to a distal end of the link arm, the actuator extending to move the rocker arm to an extended position and retracting to move the rocker arm to a retracted position; and
drive means engaging each front wheel and each rear wheel.

2. The multiple-lifting-tandems suspension of claim 1 wherein the actuator comprises one of: a hydraulic cylinder; a pneumatic cylinder; and an electrically powered linear actuator—or a combination of those elements.

3. The multiple-lifting-tandems suspension of claim 1 wherein each front wheel and each rear wheel has a hub driven by an electrically powered motor.

4. The multiple-lifting-tandems suspension of claim 1 wherein each front wheel and each rear wheel has a hub driven by a hydraulically powered motor.

5. The multiple-lifting-tandems suspension of claim 1 wherein each front wheel and each rear wheel has a hub driven by one of:
a sprocket and chain drive; a drive-shaft; and a pulley and belt drive, connected to an engine and transmission.

6. The multiple-lifting-tandems suspension of claim 5 wherein the chain drive is housed within the rocker arm and the link arm.

7. The multiple-lifting-tandems suspension of claim 5 wherein the belt drive is housed within the rocker arm and the link arm.

8. The multiple-lifting-tandems suspension of claim 5 wherein the drive shaft is housed within the rocker arm and the link arm.

9. The multiple-lifting-tandems suspension of claim 5 wherein the hub incorporates a differential gear.

10. A vehicle comprising:
a chassis with a multiple-lifting-tandems suspension comprising four lifting tandem pairs;
wherein each lifting tandem pair comprises
a front wheel rotatably mounted to a front portion of a rocker arm and a rear wheel rotatably mounted to a rear portion of the rocker arm whereas both wheels may or may not be steerable;
a link arm having a proximal end rotatably mounted to the chassis and a distal end rotatably mounted to a central portion of the rocker arm—whether at the exact center of the rocker arm or off-center;
an actuator having a proximal end rotatably mounted to the chassis a distance from the proximal end of the link arm and a distal end rotatably mounted to a central portion of the rocker arm or to a distal end of the link arm, the actuator extending to move the rocker arm to an extended position and retracting to move the rocker arm to a retracted position; and
drive means engaging each front wheel and each rear wheel, while the hub at the central portion of the rocker arm may or may not incorporate a differential gear.

11. The vehicle of claim 9 wherein the chassis includes one of:
an auxiliary idler approach wheel, and a pair of auxiliary idler approach wheels, rotatably mounted to a forward edge.

12. The vehicle of claim 9 wherein the chassis includes one of:
an auxiliary idler departure wheel, and a pair of auxiliary idler departure wheels, rotatably mounted to a rearward edge.

13. The vehicle of claim 9 whereas the auxiliary approach wheels and/or the auxiliary departure wheels are powered, either by the engine of the vehicle or by another ancillary system e.g. hydraulic or electrical.

14. The vehicle of claim 9 wherein the drive means comprise an engine and transmission disposed in a central portion of the chassis.

15. A vehicle comprising:
a chassis with a multi-lifting-tandems suspension comprising one of: six, eight, ten and twelve tandem pairs;
wherein each lifting tandem pair comprises
a front wheel rotatably mounted to a front portion of one of a rocker arm and a rear wheel rotatably mounted to a rear portion of the rocker arm, whereas both wheels may or may not be steerable;
a link arm having a proximal end rotatably mounted to the chassis and a distal end rotatably mounted to a central portion of the rocker arm;
an actuator having a proximal end rotatably mounted to the chassis a distance from the proximal end of the link arm and a distal end rotatably mounted to a central portion of the rocker arm or to a distal end of the link arm, the actuator extending to move the rocker arm to an extended position and retracting to move the rocker arm to a retracted position; and
drive means engaging each front wheel and each rear wheel.
